(19) United States
(12) Patent Application Publication
(10) Pub. No.: US 2013/0135496 A1
(43) Pub. Date: May 30, 2013

(54) IMAGE PROCESSING DEVICE, IMAGE PROCESSING METHOD, AND PROGRAM

(71) Applicant: Sony Corporation, Tokyo (JP)

(72) Inventor: Yoshikuni Nomura, Tokyo (JP)

(73) Assignee: Sony Corporation, Tokyo (JP)

(21) Appl. No.: 13/680,443

(22) Filed: Nov. 19, 2012

(30) Foreign Application Priority Data
Nov. 29, 2011 (JP) 2011-261035

(51) Int. Cl. G06K 9/62; G06K 9/78

(52) U.S. Cl. CPC G06K 9/6217; G06K 9/78
USPC 348/231.6; 382/160

(57) ABSTRACT

An image processing device includes: an image probability model generation unit calculating a feature amount in units of local regions as division regions of a captured image of an imaging apparatus and generating an image probability model configured by the calculated feature amount, the image probability model indicating the generation probability of each noiseless pixel value; a memory storing a noise probability model generated from imaging element-dependent noise characteristic information, the noise probability model indicating the conditional probability of a given noised pixel value being generated in a case where a given noiseless pixel value is generated; and a Bayesian estimation unit generating a noise reduced image in which the noise of the captured image is reduced through a Bayesian estimation process in which the image probability model and the noise probability model are applied.

### BACKGROUND

The present disclosure relates to an image processing device, an image processing method, and a program. In more detail, the present disclosure relates to an image processing device performing a reduction process of noise included in an image, an image processing method, and a program.

In recent years, the number of pixels in imaging elements for digital cameras and the like have been increasingly rapidly, that is, there has been an increase in the number of pixels. As a result, individual pixels have become miniaturized, and an increase in the amount of noise due to the miniaturization of pixels has become a serious problem.

There have been various proposals in the related art as reduction processes for noise generated in each pixel of an imaging element during image capturing. However, there is a problem that even when a noise reduction technique of the related art is applied, a sufficient effect is not exhibited on a modern imaging element with miniaturized pixels.

One reason for noise reduction techniques of the related art not working effectively is thought to be insufficient noise modeling. There are various causes of noise generation on an imaging element, and the generated noise behaves differently according to the respective causes.

With the noise reduction techniques of the related art, noise is often modeled as additive Gaussian noise, which is a rough estimate for a noise model of an imaging element.

There are various techniques of noise reduction processes of the related art, such as an-old fashioned filter application process such as, for example, a median filter or a Wiener filter.

Further, there are noise reduction techniques applying a bilateral filter as noise reduction techniques that have been used widely in recent years.

Here, a noise reduction technique applying the bilateral filter is described, for example, in C. Tomasi and R. Manduchi, “Bilateral Filtering for Gray and Color Images”, Proceedings of the IEEE International Conference on Computer Vision, 1998.

Further, many NL-means techniques are also used.

An NL-means technique is described, for example, in A. Buades, B. Coll, and J. M. Morel, “A Non Local Algorithm for Image Denoising”, Proceedings of the IEEE International Conference on Computer Vision and Pattern Recognition, 2005.

In the two noise reduction methods, there are no considerations for the details of the features of the noise itself, and the processing content is a process keeping additive Gaussian noise in mind.

Meanwhile, noise reduction techniques taking the behavior of noise in an imaging element into consideration are proposed in H. Phelippeau et al., “Shot Noise Adaptive Bilateral Filter”, Proceedings of 9^{th} International Conference on Signal Processing, 2008 and Japanese Unexamined Patent Application Publication No. 2011-101359: “Integrated Noise Modeling Method of Image Sensor and Noise Reduction Method Using Modeling Method”.

H. Phelippeau et al., “Shot Noise Adaptive Bilateral Filter”, Proceedings of 9^{th} International Conference on Signal Processing, 2008 discloses a noise reduction process taking optical shot noise out of the noise of an imaging element into consideration. Further, Japanese Unexamined Patent Application Publication No. 2011-101359 described above proposes a noise reduction technique taking dark current noise, optical shot noise, and fixed pattern noise into consideration.

With the processes described in such literatures, a more effective noise reduction process is possible on an image captured by an imaging element than with a process not taking the behavior of noise into consideration.

However, since both H. Phelippeau et al., “Shot Noise Adaptive Bilateral Filter”, Proceedings of 9^{th} International Conference on Signal Processing, 2008 described above and Japanese Unexamined Patent Application Publication No. 2011-101359 described above use a bilateral filter as a filter for a noise reduction process, the processes simulate Gaussian noise as the noise.

In the case of Japanese Unexamined Patent Application Publication No. 2011-101359 described above, the individual elements of noise are all approximated by Gaussian noise, and are approximated by one element of Gaussian noise integrating the individual elements of noise.

However, there is a problem that the actual behavior of noise in an imaging element is not the same as Gaussian noise, and as a result, the error between the actual noise and Gaussian noise diminishes the noise removal performance.

Random telegraph noise recognized as one type of noise occurring in an imaging element is not Gaussian noise as shown in, for example, X. Wang, P. R. Rao, A. Mierop and A. J. P. Theuwissen, “Random telegraph signal in CMOS image sensor pixels”, The Netherlands Technical Digest, International Electron Device Meeting, 2006.

Furthermore, a process treating noise as an arbitrary probability density function without approximating as a specific pattern is disclosed in Japanese Unexamined Patent Application Publication No. 2006-310999: “Image Processing Device, Method, and Program”, which is superior to the techniques described above.

However, the configuration of Japanese Unexamined Patent Application Publication No. 2006-310999 has a problem in performing a noise reduction process using histogram matching.

The process matches a histogram of an image including noise and originally captured image signals with a histogram of ideal noise and extracts the original image signal components, and the order of pixel values included in the image before and after the histogram matching does not change.

However, in a case where noise is overlapped on an image signal that does not actually include noise, since the order of the pixel values may change, the process does not match the actual phenomenon. There is therefore a problem that noise removal performance is not sufficiently exhibited.

### SUMMARY

It is desirable to provide an image processing device, an image processing method, and a program performing a process of effectively removing or reducing noise included in an image.

With the configurations of embodiments of the present disclosure, a high-performance noise reduction process is realized by representing the behavior of noise as a sophisticated probability mode. It is further desirable to provide an image processing device, an image processing method, and a program realizing effective noise reduction even in an environment with few calculation resources by compressing the data size of the probability model and making a high-speed noise reduction process possible.

According to an embodiment of the present disclosure, there is provided an image processing device including: an image probability model generation unit calculating a feature amount in units of local regions as division regions of a captured image of an imaging apparatus and generating an image probability model configured by the calculated feature amount, the image probability model indicating the generation probability of each noiseless pixel value; a memory storing a noise probability model generated from imaging element-dependent noise characteristic information, the noise probability model indicating the conditional probability of a given noised pixel value being generated in a case where a given noiseless pixel value is generated; and a Bayesian estimation unit generating a noise reduced image in which the noise of the captured image is reduced through a Bayesian estimation process in which the image probability model and the noise probability model are applied.

Furthermore, in the image processing device, the image probability model generation unit may include: a local pixel selection unit selecting, from a local region including a noise reduction process target pixel, a pixel in which the pixel value difference with the noise reduction process target pixel is equal to or less than a threshold value as a reference pixel; and a local mean variance calculation unit calculating the mean value and the variance value of the reference pixel selected by the local pixel selection unit, wherein the image probability model may be an approximate image probability model formed of a calculation value of the local mean variance calculation unit.

Furthermore, in the image processing device, the noise probability model stored in the memory may be an approximate noise probability model generated by applying a Gaussian mixture model approximation representing an arbitrary distribution by adding a plurality of Gaussian distributions.

Furthermore, in the image processing device, the noise probability model stored in the memory may be an approximate noise probability model generated by applying a Gaussian mixture model approximation representing an arbitrary distribution by adding a plurality of Gaussian distributions, and parameters of the Gaussian mixture model approximation may be parameters calculated by applying an EM (Expectation-Maximization) algorithm.

Furthermore, in the image processing device, the noise probability model stored in the memory may be a noise probability model generated by applying simulation process data virtually generating a pixel value in which noise signals according to a plurality of noise generation causes occurring on a captured image of an imaging element overlap.

Furthermore, in the image processing device, the image probability model generation unit may generate an approximate image probability model formed of a single normal distribution, the noise probability model stored in the memory may be an approximate noise probability model generated by applying a Gaussian mixture model approximation representing an arbitrary distribution by adding a plurality of Gaussian distributions, and the Bayesian estimation unit may generate a noise reduced image in which the noise of the captured image is reduced through a Bayesian estimation process applying the approximate image probability model and the approximate noise probability model.

Furthermore, in the image processing device, the image processing device may further include: a noise probability model generation unit generating the noise probability model, wherein the noise probability model generation unit may include a noise simulation processing unit virtually generating a pixel value in which noise signals according to a plurality of noise generation causes occurring on a captured image of an imaging element overlap, and a Gaussian model approximation unit generating an approximate noise probability model through a Gaussian mixture model (GMM) approximation process on data generated by the noise simulation processing unit.

According to another embodiment of the present disclosure, there is provided an imaging apparatus including: an imaging unit including an imaging element; an image probability model generation unit calculating a feature amount in units of local regions as division regions of a captured image input from the imaging unit and generating an image probability model configured by the calculated feature amount, the image probability model indicating the generation probability of each noiseless pixel value; a memory storing a noise probability model generated from imaging element-dependent noise characteristic information, the noise probability model indicating the conditional probability of a given noised pixel value being generated in a case where a given noiseless pixel value is generated; and a Bayesian estimation unit generating a noise reduced image in which the noise of the captured image is reduced through a Bayesian estimation process in which the image probability model and the noise probability model are applied.

According to still another embodiment of the present disclosure, there is provided an image processing method including executing on an image processing device, including: an image probability model generating process including calculating a feature amount in units of local regions as division regions of a captured image of an imaging apparatus and generating an image probability model configured by the calculated feature amount, the image probability model indicating the generation probability of each noiseless pixel value; and a Bayesian estimation process generating a noise reduced image in which the noise of the captured image is reduced through Bayesian estimation by applying a noise probability model generated from imaging element-dependent noise characteristic information, the noise probability model indicating the conditional probability of a given noised pixel value being generated in a case where a given noiseless pixel value is generated, and the image probability model.

According to still another embodiment of the present disclosure, there is provided a program causing an image process to be executed on an image processing device, including: an image probability model generating process including calculating a feature amount in units of local regions as division regions of a captured image of an imaging apparatus and generating an image probability model configured by the calculated feature amount, the image probability model indicating the generation probability of each noiseless pixel value; a Bayesian estimation process generating a noise reduced image in which the noise of the captured image is reduced through Bayesian estimation by applying a noise probability model generated from imaging element-dependent noise characteristic information, the noise probability model indicating the conditional probability of a given noised pixel value being generated in a case where a given noiseless pixel value is generated, and the image probability model.

Here, the program according to an embodiment of the present disclosure is a program provided to an information processing device or a computer system able to execute various program codes, for example by a storage medium, for example. Processes according to the program are realized by such a program being executed by a program execution unit on the information processing device or the computer system.

Further objects, characteristics, and advantages of embodiments of the present disclosure will be made clear in the detailed description based on the embodiments of the present disclosure described later and the attached drawings. Here, a system in the present specification is a logically collected configuration of a plurality of devices, and is not limited to devices of each configuration being within the same housing.

According to an embodiment of the present disclosure, a device and a method performing a reduction process of the noise included in a captured image are realized.

Specifically, a noise reduced image in which the noise of a captured image is reduced is generated through a Bayesian estimation process applying an image probability model generation unit calculating a feature amount in units of local regions as division regions of a captured image of an imaging apparatus and generating an image probability model configured by the calculated feature amount, the image probability model indicating the generation probability of each noiseless pixel value, a memory storing a noise probability model generated from imaging element-dependent noise characteristic information, the noise probability model indicating the conditional probability of a given noised pixel value being generated in a case where a given noiseless pixel value is generated, an image probability model, and a noise probability model.

According to the configuration of the embodiments of the present disclosure, a high-performance noise reduction process taking into consideration the noise characteristics of an imagine element and the characteristics of the region units of an image is able to be realized. Furthermore, a reduction in the amount of data used, a reduction in the calculation amount, and high-speed processing are able to be realized through an approximation process.

### BRIEF DESCRIPTION OF THE DRAWINGS

FIG. 1 is a view describing a configuration example of an imaging apparatus as an embodiment of an image processing device;

FIG. 2 is a view describing an example of the configuration of an imaging element and a captured image;

FIG. 3 is a view illustrating a portion of a noise probability model of an imaging element used in an image processing device according to an embodiment of the present disclosure;

FIG. 4 is a view describing a three-dimensional probability density function in which an axis of noised pixel values (0 to 255) is further set on the correspondence relationship data between noiseless pixel values (0 to 255) illustrated in FIG. 3 and the presence probability of each pixel value;

FIG. 5 is a view describing a graph illustrating a prior probability P(A) before an image is captured, that is, the probability P(A) of a pixel value A not including noise occurring;

FIG. 6 is a view illustrating the probability P(A) of the pixel value A not including noise occurring in a case where there is prior knowledge that the brightness of a subject is uniform (pixel value=a);

FIG. 7 is a view describing an example of a given local region (7×7 pixels) of a captured image including edges divided between light and dark;

FIG. 8 is a view describing a histogram of the pixel values of the image illustrated in FIG. 7;

FIG. 9 is a view describing a method of creating a probability model by removing pixel values far from the pixel value of the target pixel position from the local region so that there is a single peak;

FIG. 10 is a view describing a detailed configuration example for executing a noise reduction process; and

FIG. 11 is a view describing another detailed configuration example for executing a noise reduction process.

### DETAILED DESCRIPTION OF EMBODIMENTS

Details of the image processing device, the image processing method, and the program according to embodiments of the present disclosure will be described below by referring to the drawings. Description will be made according to the following items.

1. Overall Configuration and Process of Image Processing Device According to Embodiment of Present Disclosure

2. Noise Reduction Process Executed by Image Processing Device According to Embodiment of Present Disclosure

3. Configuration and Processing Example of Signal Processing Unit (DSP) in Imaging Apparatus

4. Process of Approximate Noise Probability Model Generation Unit

5. Generation Process of Approximate Image Probability Model

6. Embodiment Variation

7. Summary of Configuration of Embodiments of Present Disclosure

### 1. Overall Configuration and Process of Image Processing Device According to Embodiment of Present Disclosure

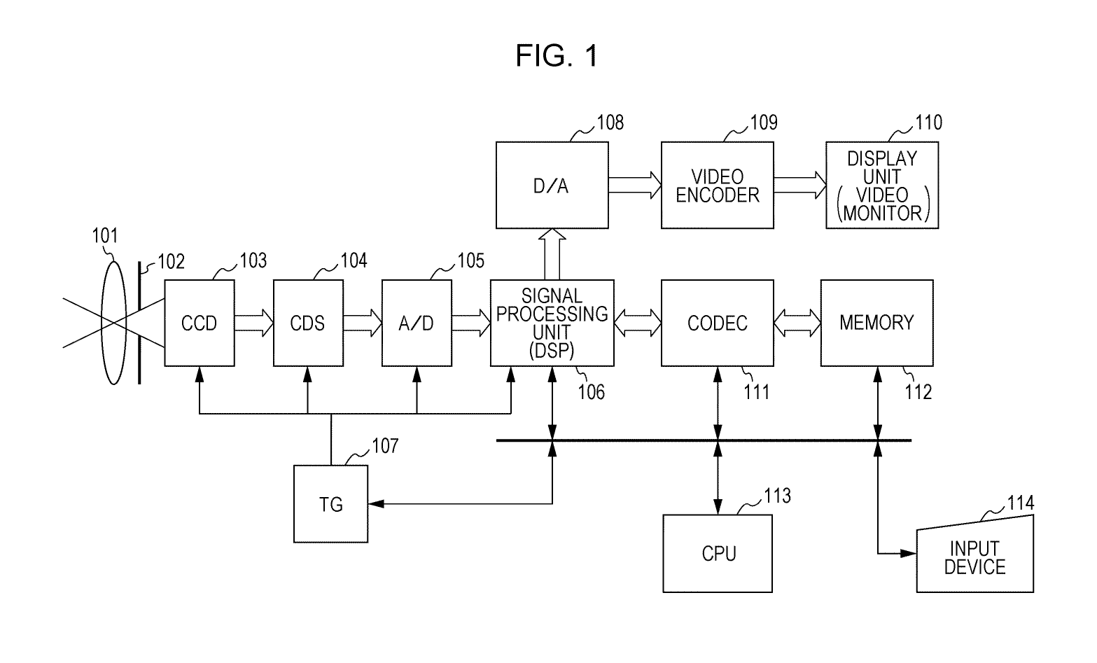

First, the overall configuration and the process of an imaging apparatus (digital camera) as an embodiment of the image processing device according to an embodiment of the present disclosure will be described with reference to FIG. 1.

As illustrated in FIG. 1, the imaging apparatus includes a lens 101 as an imaging unit, an aperture 102, a CCD image sensor 103, a correlated double sampling circuit (CDS) 104, an A/D converter 105, a signal processing unit (DSP) 106, a timing generator (TG) 107, a D/A converter 108, a video encoder 109, a display unit (video monitor) 110, a CODEC 111, a memory 112, a CPU 113, and an input device 114.

The input device 114 is configured by operation buttons such as a record button on the camera main body. Further, the signal processing unit (DSP) 106 has a configuration of including a signal processing processor and a storage unit (RAM) storing an image as the target of the signal processing by the processor and parameters. The signal processing processor performs image processing programmed in advance on the image data stored in the storage unit. The noise reduction process of an image described in the following embodiment is a process mainly executed by the signal processing unit (DSP) 106.

Incident light passing through the optical system such as the lens 101 and the aperture 102 configuring the imaging unit and reaching the CCD image sensor 103 as the imaging element first reaches light receiving elements in units of each pixel on the CCD imaging face, and is converted into an electrical signal according to the light receiving amount in units of each pixel through photoelectric conversion at the light receiving elements.

The electrical signals in units of each pixel output from the CCD image sensor 103 is input into the correlated double sampling circuit (CDS) 104. In the correlated double sampling circuit (CDS) 104, the removal process of reset noise as the main component of the noise included in the output signal from the CCD image sensor 103 is performed.

The correlated double sampling circuit (CDS) 104 removes the reset noise as the main component of the noise included in the output signal from the CCD image sensor 103. Specifically, the reset noise is removed by subtracting each pixel signal of the output in which the picture signal period has been sampled and the standard period has been sampled.

Here, the noise removal process executed in the correlated double sampling circuit (CDS) 104 only removes a portion of the noise included in the image, and there is still significant noise included in the image. A reduction process of the remaining noise is executed by the signal processing unit (DSP) 106.

The noise reduction process executed by the signal processing unit (DSP) 106 will be described in detail later.

The output of the correlated double sampling circuit (CDS) 104 is input into the A/D converter 105, converted into digital data, input into the signal processing unit (DSP) 106, and stored in a storage unit (RAM) within the signal processing unit (DSP) 106.

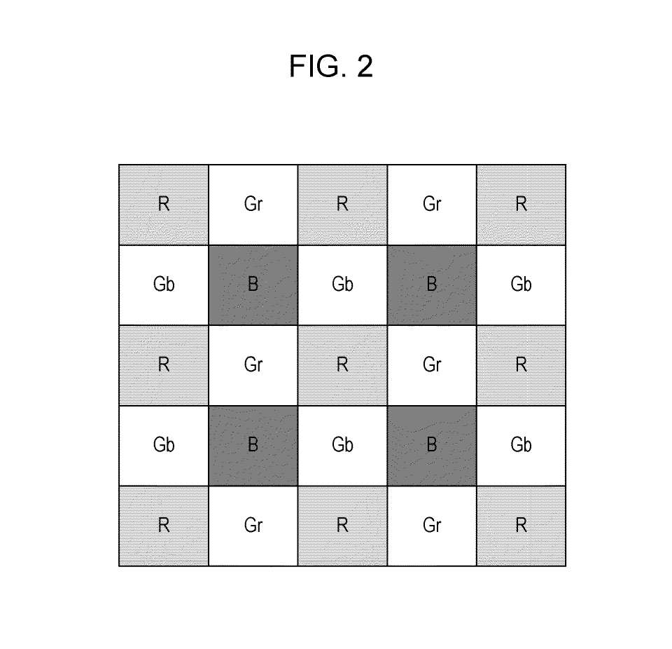

Here, the captured image stored in the storage unit (RAM) within the signal processing unit (DSP) 106 is image data according to the color sequence of the CCD image sensor 103 as the imaging element, that is, for example, a mosaic image in which the pixel values of any of RGrGbB are set in units of each pixel as illustrated in FIG. 2.

The color sequence illustrated in FIG. 2 is a sequence referred to as a Bayer arrangement, which is used in many digital cameras.

The captured image stored in the storage unit (RAM) within the signal processing unit (DSP) 106 is a mosaic image in which the pixel values corresponding to one color in units of each pixel are set according to such a color sequence.

Here, the color sequence (Bayer arrangement) illustrated in FIG. 2 is an example of a color sequence, and the image processing device according to an embodiment of the present disclosure is also able to be applied to a captured image with a different sequence.

The signal processing unit (DSP) 106 performs signal processing on the mosaic image illustrated in FIG. 2, for example, stored in the storage unit (RAM) within the signal processing unit (DSP) 106. Specifically, the signal processing unit (DEP) 106 performs the noise reduction process of an embodiment of the present disclosure described later. Furthermore, an image for display and an image for storage are generated by executing generic image processing such as a demosaic process, gamma compensation, and white balance adjustment of setting all pixel values of RGB for each pixel.

Here, when the imaging apparatus is in an image capturing state, the timing generator (TG) 107 controls the signal processing system to maintain image capturing at a fixed frame rate.

Stream data of pixel signals configuring each image is also input into the signal processing unit (DSP) 106 at a fixed rate. The signal processing unit (DSP) 106 executes various image processes including a noise reduction process by inputting such stream signals. The image data is then output to the D/A converter 108, the CODEC 111, or to both.

The D/A converter 108 converts the image data input from the signal processing unit (DSP) 106 into an analog signal. Furthermore, the video encoder 109 converts the analog signal into a video signal, and outputs the video signal to the display unit (video monitor) 110.

Here, the display unit (video monitor) 110 also functions as a finder for the camera.

Further, the CODEC 111 performs an encoding process on the image data output from the signal processing unit (DSP) 106, and the encoded image data is stored in the memory 112.

The memory 112 is configured by a recording device or the like using a semiconductor, a magnetic recording medium, a magneto-optical recording medium, an optical recording medium, or the like.

### 2. Noise Reduction Process Executed by Image Processing Device According to Embodiment of Present Disclosure

As described above, an image captured by the imaging apparatus illustrated in FIG. 1 has a noise reduction process executed by the signal processing unit (DSP) 106.

Before describing the specific configuration and process of the signal processing unit (DSP) 106, the outline of the noise reduction process that the signal processing unit (DSP) 106 executes will be described.

The image processing device according to an embodiment of the present disclosure executes a noise reduction process using the two probability models of:

(A) a noise probability model of the imaging element; and

(B) a probability model of the image captured by the imaging element.

A noise reduction process is performed on the image captured by the imaging element through a Bayesian estimation using the two probability models.

(A) The noise probability model of the imaging element is a probability density function indicating an ideal pixel value for a pixel value at which noise is overlapped due to various causes of noise on the imaging element, that is, the probability of an ideal pixel value at which no noise is included.

(B) The probability model of the image is a probability density function of a pixel value that a pixel at the target pixel position as the noise reduction target may adopt, and different probability density functions are able to be set for each pixel.

A pixel value (Y) obtained through a noise removal process based on Bayesian estimation on a pixel value (X) of a pixel including noise is calculated by the following Formula 1.

$$Y = {\sum }_{A} A \times \frac{P ( X \vert A ) P ( A )}{{\sum }_{B} P ( X \vert B ) P ( B )} \qquad Formula 1$$

In Formula 1 described above, A and B represent ideal pixel values not including noise, X represents a pixel value including noise, and Y represents a pixel value in which noise is removed from X.

P(X|A) is referred to as the “likelihood”, and here, is the conditional probability of the noised pixel value X occurring in a case where the noiseless pixel value A occurs, and represents the “noise probability model” of the imaging element described above.

Similarly, P(X|B) is also the “likelihood”, is the conditional probability of the noised pixel value X occurring in a case where the noiseless pixel value B occurs, and represents the “noise probability model” of the imaging element described above.

P(A) is referred to as the prior probability, and here, is the probability of the noiseless pixel value A occurring, and represents the “probability model of the image” described above.

Similarly, P(B) is also a prior probability, is the probability of the noiseless pixel value B occurring, and represents the “probability model of the image” described above.

That is, the “noise probability model” indicates the conditional probability of a given noised pixel value occurring in a case where a given noiseless pixel value occurs. The noise probability model is data dependent on the imaging apparatus, in particular, the imaging element.

Further, the “probability model of the image” indicates the occurrence probability of each noiseless pixel value. The probability model of the image is data dependent on the captured image.

Here, the “likelihood” corresponding to the “noise probability model” is the probability density function determined by the noise characteristics of the imaging element (the CCD image sensor 103 illustrated in FIG. 1), and is determined by various noise characteristics such as, for example, dark current noise, optical shot noise, fixed pattern noise, and circuit noise.

Such individual noise characteristics have been studies in the related art, and for example, in relation to optical shot noise, it is recognized that the square root of the number of photons incident on a pixel is the optical shot noise.

Here, the noise modeling techniques are described, for example, in the following non-patent literatures.

(a) Kazuya Yonemoto, “Foundations and Applications of CCD/CMOS Image Sensors”

(b) R. Gow et al., “A Comprehensive Tool for Modeling CMOS Image Sensor Noise Performance”, IEEE Transactions on Electron Devices, 2007

To be able to model noise is to be able to ascertain the pixel values including noise by adding noise to pixel values not including noise.

The non-patent literature “A Comprehensive Tool for Modeling CMOS Image Sensor Noise Performance” described above and the non-patent literature “Image Systems Evaluation Toolbox by ImagEval Consulting LLC”, and the like are recognized as software able to perform such a simulation.

In the image processing device according to an embodiment of the present disclosure, a noise reduction process is performed by applying the “noise probability model” of the imaging element generated using modeled noise.

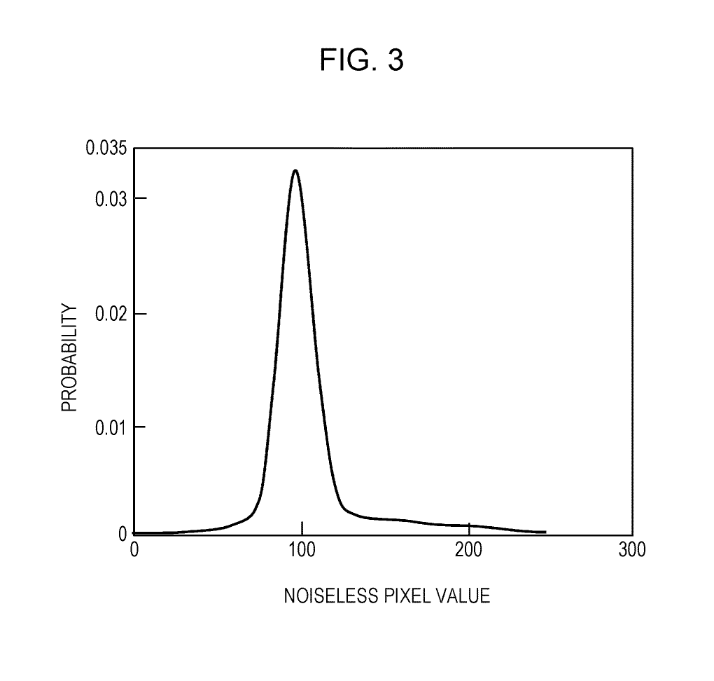

FIG. 3 is a view illustrating a portion of the noise probability model of the imaging element used in the image processing device according to an embodiment of the present disclosure.

FIG. 3 is a probability density function representing, for the pixel value of a pixel including a given noise, at what value and at what probability there is a pixel value not including the original noise (noiseless pixel value). The horizontal axis indicates the noiseless pixel value (0 to 255) and the vertical axis indicates the presence probability of each pixel value. Here, while the presence probability differs depending on the imaging element, the data illustrated in FIG. 3 is data based on one typical model image.

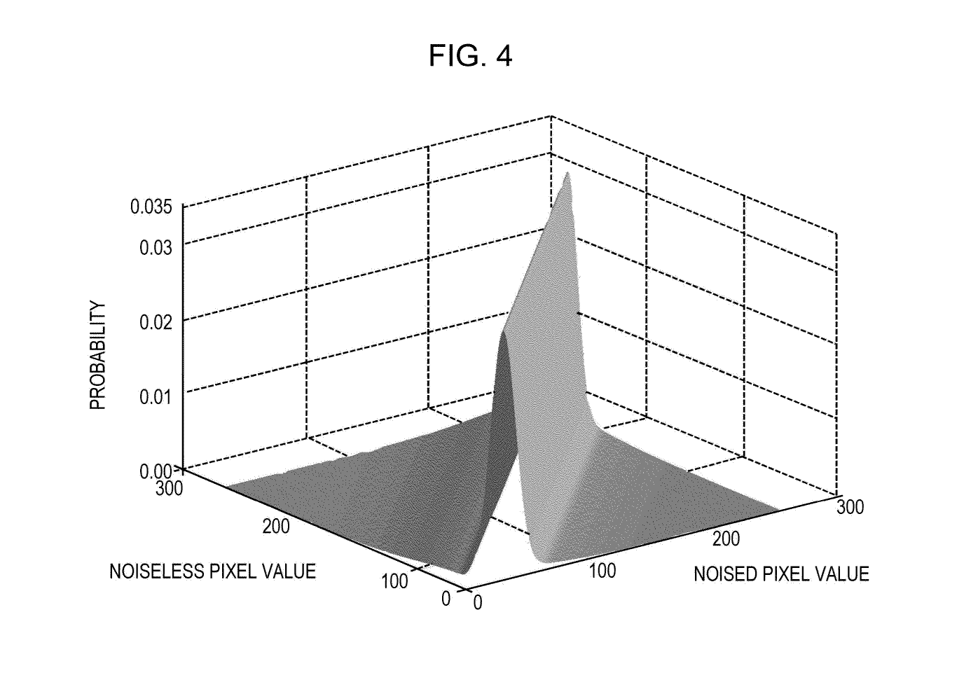

FIG. 4 is a three-dimensional probability density function in which an axis of noised pixel value (0 to 255) is further set on the correspondence relationship data between the noiseless pixel values (0 to 255) illustrated in FIG. 3 and the presence probability of each pixel value.

The two-dimensional graph illustrated in FIG. 3 corresponds the three-dimensional graph illustrated in FIG. 4 with sliced data for a pixel value including one given noise.

The likelihood P(X|A), that is, the conditional probability of the noised pixel value X occurring in a case where the noiseless pixel value A occurs is able to be found in advance through a simulation of the noise.

However, it is difficult to find the “prior probability P(A)”, that is, the probability of the noiseless pixel value A occurring, which is the other important item included in Formula 1 described above.

The reason is that since P(A) is the probability of the pixel value A not including noise occurring and the pixel value may change in any way according to the subject, only that all pixel values occur with the same probability is certain before an image is captured.

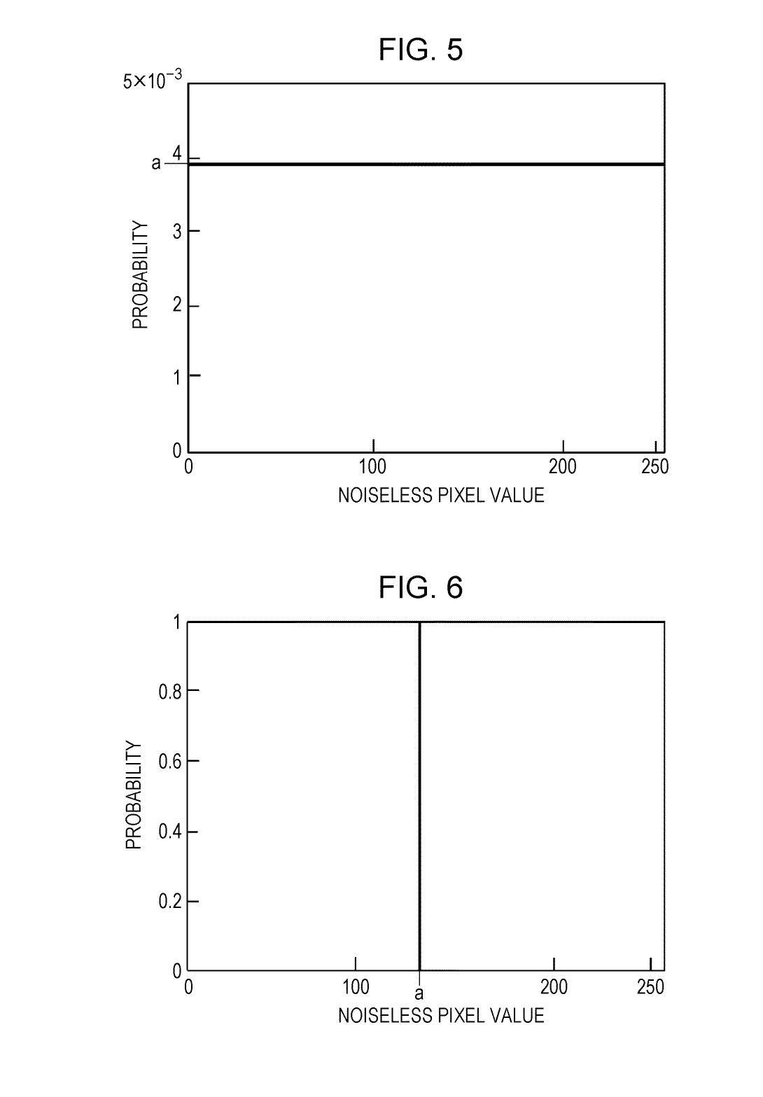

FIG. 5 is a graph illustrating the prior probability P(A) before an image is captured, that is, the probability P(A) of the pixel value A not including noise occurring.

The probability of the pixel value A not including noise occurring is the same probability (1/256˜3.9×10⁻³) for all pixel values (0 to 255 in the present example).

Bayesian estimating using the prior probability P(A) illustrated in FIG. 5 is equal to maximum likelihood estimation.

It is generally accepted that the performance of maximum likelihood estimation is inferior to Bayesian estimation. The reason is that in a case where there is some prior knowledge that the probability P(A) of the pixel value A not including noise occurring is not uniform, using such information allows an estimation with greater accuracy.

For example, in a case where there is prior knowledge that the brightness of a subject is uniform (pixel value=a), as illustrated in FIG. 6, the probability P(A) of the pixel value A not including noise occurring is 1 for one given brightness a, and 0 for any other brightness.

In such a case, with Formula 1 described above calculating the pixel value Y in which the noise is removed from the pixel value X of a pixel including noise using Bayesian estimation, the pixel value a is able to be estimated from the pixel value X on which noise is overlapped (where P(X|a)≠0 is a condition).

On the other hand, with maximum likelihood estimation, since the prior probability P(A) of the pixel value A not including noise occurring is the uniform probability illustrated in FIG. 5, different pixel values are estimated depending on the noise probability model used.

That is, with Bayesian estimation, the accuracy of the prior probability has a large influence on the estimation performance.

The prior probability is able to be given subjectively, and the user may set the prior probability freely according to prior knowledge.

With the configuration according to an embodiment of the present disclosure, the prior probability is generated using a captured image including noise.

Specifically, a histogram of pixel values present in a local region including the target pixel position as the noise reduction process target is used as the prior probability.

With a narrow local region of a pixel region of, for example, approximately 7×7, 9×9, or 11×11 included in the captured image, it is estimated that the subject does not exhibit an extreme change, and the range of pixel values able to be taken within the local region is narrow. Therefore, even if there is noise mixed into a signal (a pixel value of the captured image), if the signal dominates the noise, the range of pixel values able to be taken within the local region is still narrow. Even if the subject changes within the local region, the distribution of pixel values is clear one-sided.

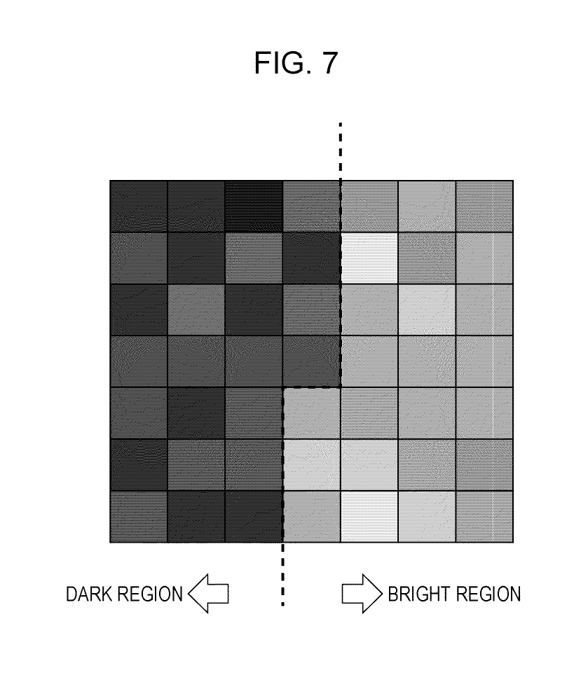

An example of a given local region (7×7 pixels) of a captured image is illustrated in FIG. 7. The local region includes edges divided in two into light and dark.

An ideal pixel value of the dark region not including noise is b, and an ideal pixel value of a light region not including noise is c.

Here, noise is overlapped on an actual pixel value, and the pixel value is deviated from b and c.

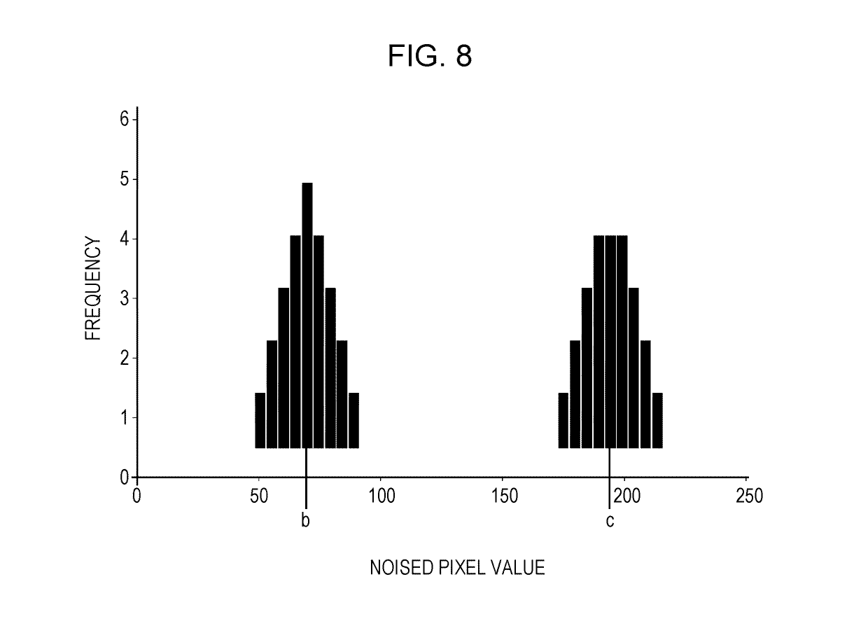

FIG. 8 is a histogram of the pixel values of the local region illustrated in FIG. 7.

The horizontal axis is the pixel value (0 to 255) and the vertical axis is the number of pixels that appear.

As is understood from FIG. 8, in the local region of 7×7 pixels illustrated in FIG. 7, the pixel values are concentrated at values in the vicinity of a pixel value corresponding to approximately the average pixel value of the dark region=b and values in the vicinity of a pixel value corresponding to approximately the average pixel value of the light region=c, that is, values in the vicinity of the two pixel values b and c.

In a local region of an image captured using an imaging apparatus (camera), noise and slight changes in the signal influence the widths of the crests of the histogram.

It is therefore clear that the probability of the noiseless pixel value at the target pixel position being a pixel value with a high frequency of occurrence in the local region is high, and in the example illustrated in FIG. 8, there is a high probability of the noiseless pixel value at the target pixel position being a value in the vicinity of b or a value in the vicinity of c.

It is beneficial to cause such a knowledge to be reflected in the probability P(A) of the noiseless pixel value A occurring applied to the Bayesian estimation.

Furthermore, rather simply using a local histogram as P(A), it is thought than a method of improving the reliability of P(A) by further taking the noise characteristics of the image element into consideration is effective.

There is noise of the imaging element influenced by the number of photons incident on a pixel and noise of the imaging element not influenced by the number of photons incident on a pixel.

That is, there are a plurality of causes of noise with the same noise characteristics regardless of the pixel position, and the expected values of the noise are identified in advance.

The pixel value of a pixel including noise is a value in which the noise from a plurality of noise causes is added to a noiseless pixel value. By considering the additivity of the noises, when the expected value of noise identified in advance from the pixel value including noise is subtracted, it is expected that a value closer to the pixel value not including noise is able to be attained.

That is, by creating a histogram after subtracting the expected value of noise from a pixel value of a local region, a more reliable P(A), that is, the probability P(A) of the noiseless pixel value A occurring as a prior probability, is able to be calculated.

As described above, the likelihood P(X|A) as the conditional probability of the noised pixel value X occurring in a case where the noiseless pixel value A occurs is able to be calculated through a noise simulation.

Further, as the probability P(A) of the noiseless pixel value A occurring as a prior probability, a reliable value is able to be calculated from a histogram generated after the expected value of the noise is subtracted from a pixel value of a local region.

In such a manner, by calculating the likelihood P(X|A) and the probability P(A), the pixel value Y of a noiseless pixel in which noise included in a captured image is removed from the pixel value X of a noise pixel is able to be calculated by applying Formula 1 described earlier.

However, if Formula 1 described above is used as is, there is a problem that the data amount and the calculation amount become extremely large, making use by a digital camera or the like with limited calculation resources difficult.

In order to solve the problem, it is effective to use Formula 2 described below by modifying Formula 1 described above. A reduction in the calculation amount is possible by using Formula 2 described below.

The calculation amount of Formula 1 described above is large since there are two items of sum total.

For example, if the imaging element outputs a 12 bit pixel value, each sum total is performed 2¹² times.

In order to eliminate the items of sum total, Formula 2 shown below using a continuous distribution instead of Formula 1 using a discrete distribution is used.

$$Y = \frac{{\int }_{A} A \times P ( X \vert A ) P ( A ) d A}{{\int }_{B} P ( X \vert B ) P ( B ) d B} \qquad Formula 2$$

While a pixel value is ordinarily a discrete value through an A/D conversion, since a pixel value is sufficiently finely discretized, there is no problem with treating a pixel value as an approximately continuous value.

To eliminate the items of sum total from Formula 1 using a discrete distribution is equivalent to eliminating the integral items from Formula 2 using a continuous distribution.

That is, it is sufficient if the two integrated functions A×P(X|A)P(A) and P(X|B)P(B) are analytically integrated functions.

Here, a Gaussian function is used as an analytically integrated function.

As described above, the noise probability model of the imaging element and the probability model of the image both have probability distributions different from a Gaussian distribution.

Therefore, if the probability models are approximated using a single Gaussian function, the error is too large, and sufficient noise removal performance is not obtained.

Therefore, Gaussian mixture model approximation representing an arbitrary distribution with a collection of a plurality of Gaussian distributions is used.

Gaussian mixture model approximation of one-dimensional data is shown in the following Formula 3.

In a case where the function before approximation is f(x), the function f(x) is able to use the formula shown on the right side of Formula 3 as an approximate formula, and an approximate value of f(x) is able to be calculated through the approximate formula.

$$f ( x ) ≅ {\sum }_{i} {w}_{i} N ( x \vert {μ}_{i} , {σ}_{i} ) \\ where \\ N ( x \vert {μ}_{i} , {σ}_{i} ) = \frac{1}{\sqrt{2 π} {σ}_{i}} exp ( \frac{- {( x - {μ}_{i} )}^{2}}{2 {σ}_{i}^{2}} ) \\ {\sum }_{i} {w}_{i} = 1 and ∀ i \text{:} {w}_{i} \geq 0 \qquad Formula 3$$

Here, Formula 3 described above is expressed using a normal distribution, which is a type of Gaussian function.

In Formula 3 described above, f(x) represents the function before approximation, i represents an index of the normal distribution, Ni(x) represents the i-th normal distribution, and wi represents the weighting of the i-th normal function.

μi and σI represent the mean and the standard deviation of the i-th normal distribution.

Since the noise probability model of an imaging element does not depend on the subject, a noise removal process may be performed by performing Gaussian mixture model approximation over time in advance, storing the approximation result in a memory or the like, and reading and using the approximation result from the memory when performing an actual noise removal process of the captured image.

However, since the probability model of the image is dependent on the subject, Gaussian mixture model approximation is redone every time for each pixel.

While doing so is possible in a case where there are sufficient calculation resources, since the process has difficulties in an environment with few calculation resources, here, a method of approximating a single normal distribution is considered for the probability model of the image.

If a histogram is created from the pixel values of a simple rectangular local region and used as the probability model of an image, there may be a probability distribution with a plurality of peaks as illustrated in FIG. 8.

In order to perform an approximation using a single normal distribution, it is preferable to use a distribution with a single peak. Therefore, a method of creating a probability model after removing pixel values far away from the pixel value of the target pixel position from the local region so that there is a single peak will be described.

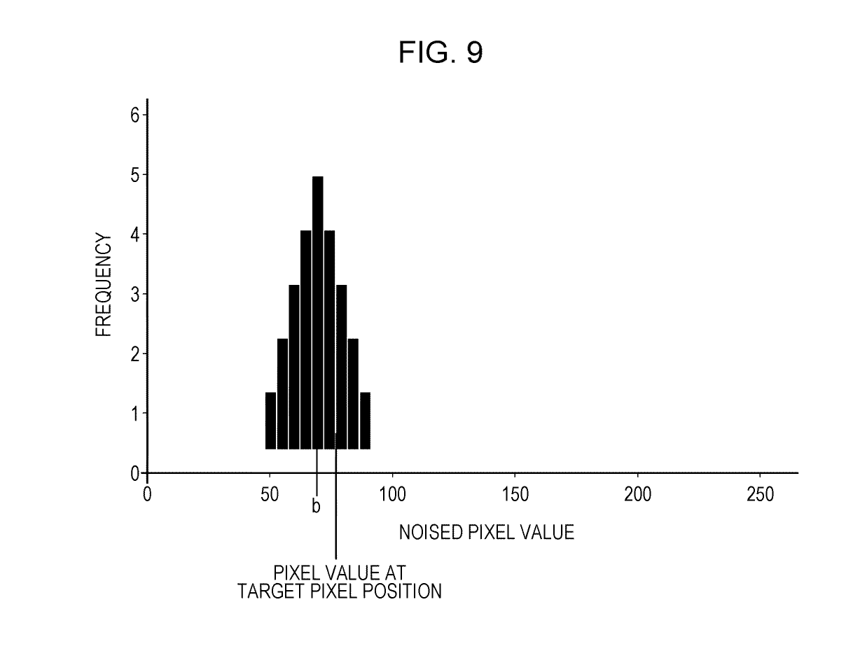

For example, in the case of the histogram illustrated in FIG. 8, if the target pixel position as the noise reduction process target has a pixel value in the vicinity of b, as illustrated in FIG. 9, only the peak in the vicinity of b may be used.

Of the selection process of the pixel value, the simplest process is a process of selecting surrounding pixels within a given threshold value by calculating the absolute value of the difference between the pixel value of the target pixel position as the noise reduction process target and the pixel values of surrounding pixel positions. A histogram with a single peak is created using the pixel values of surrounding pixels selected in such a manner, and approximation using a single normal distribution is performed based on the histogram.

In order to improve the selection performance for selecting distribution data with a single peak, rather than using a fixed threshold value, a technique of dynamically setting an appropriate threshold value according to the subject is effective.

A method of dynamically determining a threshold value will be described in the specific process of the signal processing unit (DSP) 106 later.

If a histogram is created using the pixel values of pixels selected as appropriate through a pixel selection process applying a threshold value from a local region including the target pixel as the noise reduction process target, a smooth and monomodal distribution is created, which is able to be sufficiently approximated by a single normal distribution.

Using the method described above:

(1) the noise probability model of the imaging element is approximated by a Gaussian mixture model; and

(2) the probability model of the image is approximated by a normal distribution.

As a result, Formula 2 described earlier is able to be expressed as the following Formula 4.

$$Y ( s ) ≅ \frac{\begin{matrix}{\int }_{A} A \times ( {\sum }_{i} {w ( X ( s ) )}_{i} N ( A \vert {μ ( X ( s ) )}_{i} , {σ ( X ( s ) )}_{i} ) ) \\ N ( A \vert μ ( s ) , σ ( s ) ) d A\end{matrix}}{\begin{matrix}{\int }_{B} ( {\sum }_{i} {w ( X ( s ) )}_{i} N ( B \vert {μ ( X ( s ) )}_{i} , {σ ( X ( s ) )}_{i} ) ) \\ N ( B \vert μ ( s ) , σ ( s ) ) d B\end{matrix}} \qquad Formula 4$$

Here, in the formula described above, s represents a pixel position, X(s) represents a pixel value before noise reduction, Y(s) represents a pixel value after noise reduction, i represents an index of the normal distribution, Ni(x) represents the i-th normal distribution, wi represents the weighting of the i-th normal function, and μ(s) and σ(s) represent the mean and standard deviation of the pixel value at the pixel position s.

While Formula 4 is a definite integral performing integration within a range that the pixel value may adopt, since the width of the distributions of the probability models of the imaging element and the image is narrow, there is no problem with changing to infinite integration.

When the integral item is analytically calculated having changed to infinite integration, Formula 5 shown below is obtained.

$$\begin{matrix}Y ( s ) ≅ \frac{\begin{matrix}{\int }_{A = - ∞}^{∞} A \times ( {\sum }_{i} {w ( X ( s ) )}_{i} N ( A \vert {μ ( X ( s ) )}_{i} , {σ ( X ( s ) )}_{i} ) ) \\ N ( A \vert μ ( s ) , σ ( s ) ) d A\end{matrix}}{\begin{matrix}{\int }_{B = - ∞}^{∞} ( {\sum }_{i} {w ( X ( s ) )}_{i} N ( B \vert {μ ( X ( s ) )}_{i} , {σ ( X ( s ) )}_{i} ) ) \\ N ( B \vert μ ( s ) , σ ( s ) ) d B\end{matrix}} \\ = \frac{{\sum }_{i} {w ( X ( s ) )}_{i} \frac{{e}^{- \begin{matrix}{( μ ( s ) - {μ ( X ( s ) )}_{i} )}^{2} \\ 2 ( {σ ( s )}^{2} + {σ ( X ( s ) )}_{i}^{2} )\end{matrix}}}{{( {σ ( s )}^{2} + {σ ( X ( s ) )}_{i}^{2} )}_{2}^{1}} \frac{\begin{matrix}{μ ( X ( s ) )}_{i} {( σ )}^{2} + \\ μ ( s ) {σ ( X ( s ) )}_{i}^{2}\end{matrix}}{{σ ( s )}^{2} + {σ ( X ( s ) )}_{i}^{2}}}{{\sum }_{i} {w ( X ( s ) )}_{i} \begin{matrix}{e}^{- \frac{{( μ ( s ) - {μ ( X ( s ) )}_{i} )}^{2}}{2 ( {σ ( s )}^{2} + {σ ( X ( s ) )}_{i}^{2} )}} \\ {( {σ ( s )}^{2} + {σ ( X ( s ) )}_{i}^{2} )}^{\frac{1}{2}}\end{matrix}}\end{matrix} \qquad Formula 5$$

Here, in the formula described above, s represents a pixel position, X(s) represents a pixel value before noise reduction, Y(s) represents a pixel value after noise reduction, i represents an index of the normal distribution, Ni(x) represents the i-th normal distribution, wi represents the weighting of the i-th normal function, and μ(s) and σ(s) represent the mean and standard deviation of the pixel value at the pixel position s (the mean and standard deviation of the normal distribution).

Since it is sufficient if several normal distributions are used in the approximation of the noise probability model of the imaging element, Formula 5 has a far smaller sum total of calculations compared to Formula 1 described earlier.

Therefore, even if the calculation amount used in the approximation of the probability of the image and the calculation amounts of the divisions, the square roots, and the exponent functions of Formula 5 are considered, Formula 5 has a sufficiently smaller calculation amount compared to Formula 1.

Further, if the memory amounts used to retain the noise probability model of the imaging element are compared, the memory amount used to retain the noise probability model of the imaging element approximated using a Gaussian mixture model is overwhelmingly smaller.

Through the approximation calculation described above, the calculation amount and the memory amount used in the process are reduced, making the process possible even in an environment with few calculation resources.

### 3. Configuration and Processing Example of Signal Processing Unit (DSP) in Imaging Apparatus

As described above, the image captured by the imaging apparatus illustrated in FIG. 1 has a noise reduction process executed by the signal processing unit (DSP) 106.

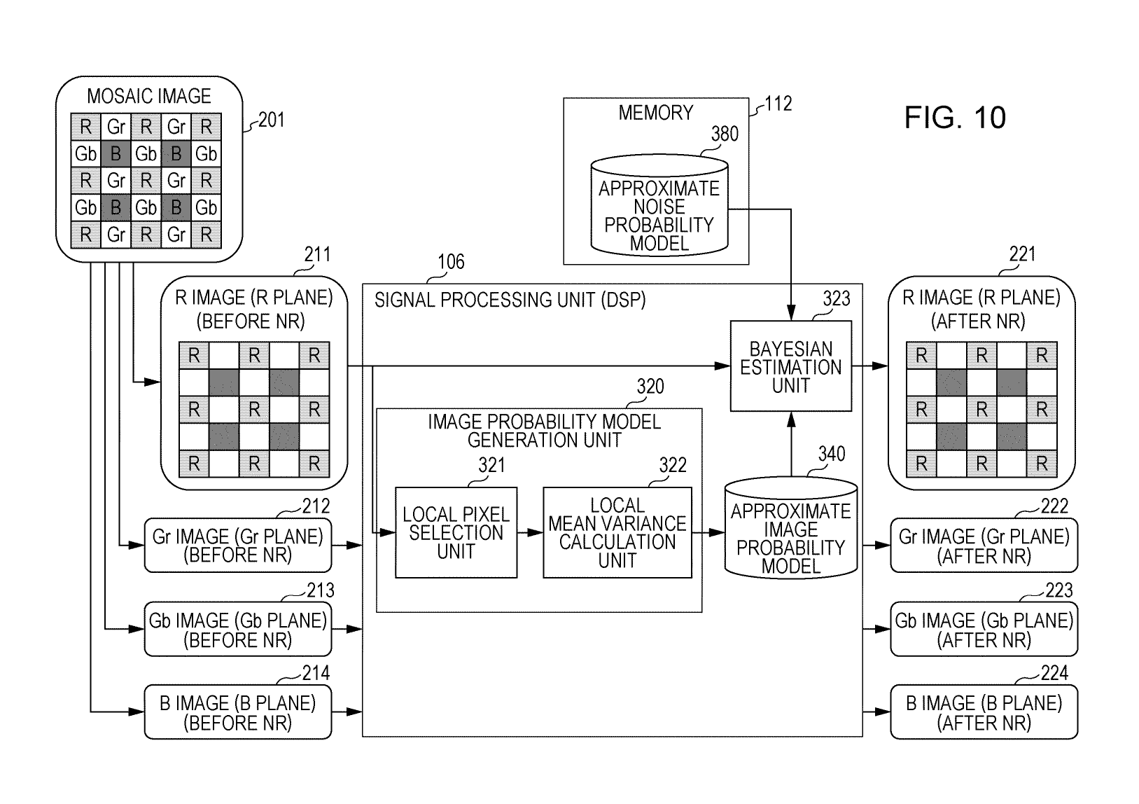

The signal processing unit (DSP) 106 has a configuration of sequentially executing a plurality of processes according to a predetermined program on the input image signal stream. A detailed configuration example for executing the noise reduction process through the signal processing unit (DSP) 106 is illustrated in FIG. 10.

Here, each process unit within the program will be described as a functional block in the following description. Here, while the signal processing unit (DSP) 106 is described as performing the noise reduction process according to a predetermined program in the following embodiment, a configuration of executing the noise reduction process through a hardware circuit realizing the same processes as the functional blocks described below may also be adopted.

As illustrated in FIG. 10, the signal processing unit (DSP) 106 includes an image probability model generation unit 320 and a Bayesian estimation unit 323. The image probability model generation unit 320 includes a local pixel selection unit 321 and a local mean variance calculation unit 322.

The local pixel selection unit 321 of the image probability model generation unit 320 selects the pixels applied to the calculation of the mean and the variance by the next local mean variance calculation unit 322 from a local region including the target pixel as the target of the noise reduction process selected from the input image (for example, an R image 211 illustrated in the drawing).

The local mean variance calculation unit 322 calculates the mean and the variance of the selected pixels in the local region using the pixels selected by the local pixel selection unit 321. The data of the mean and the variance forms an approximate image probability model 340.

The Bayesian estimation unit 323 executes a noise reduction process on the input image (for example, the R image 211 illustrated in the drawing) using the approximate image probability model 340 generates by the process of the local pixel selection unit 321 and the process of the local mean variance calculation unit 322 and an approximate noise probability model 380 stored in the memory 112.

The noise reduction process is executed as a process according to Formula 5 described above.

The noise reduced R image 221 is generated and output as a result of the noise reduction process.

Here, the input image data with respect to the signal processing unit (DSP) 106 is an image in which the reset noise is removed from the output from the CCD image sensor 103 as the imaging device of the imaging apparatus illustrated in FIG. 1 through the correlated double sampling circuit (CDS) 104 and converted into digital data through the A/D converter 105.

The image is the mosaic image described earlier with reference to FIG. 2 in which only pixel values corresponding to colors of any of RGB are set for each pixel.

The mosaic image is temporarily stored in the image memory within the signal processing unit (DSP) 106. The mosaic image is a mosaic image 201 illustrated in FIG. 10.

The signal processing unit (DSP) 106 performs processing by extracting images in units of each color signal from the mosaic image 201. In the present example, a noise removal process is performed individually for each of four color images before noise removal (pre-NR) of the R image 211, a Gr image 212, a Gb image 213, and a B image 214.

Processing on the R image 211 is illustrated as a typical example in FIG. 10.

The signal processing unit (DSP) 106 executes a noise reduction process applying Bayesian estimation on each color image, and generates and outputs each noise reduced color image, that is, each of four noise reduced (post-NR) color images of an R image 221, a Gr image 222, a Gb image 223, and a B image 224 illustrated in FIG. 10.

Here, the approximate noise probability model 380 stored in the memory 112 is able to be generated through a simulation process executed in advance.

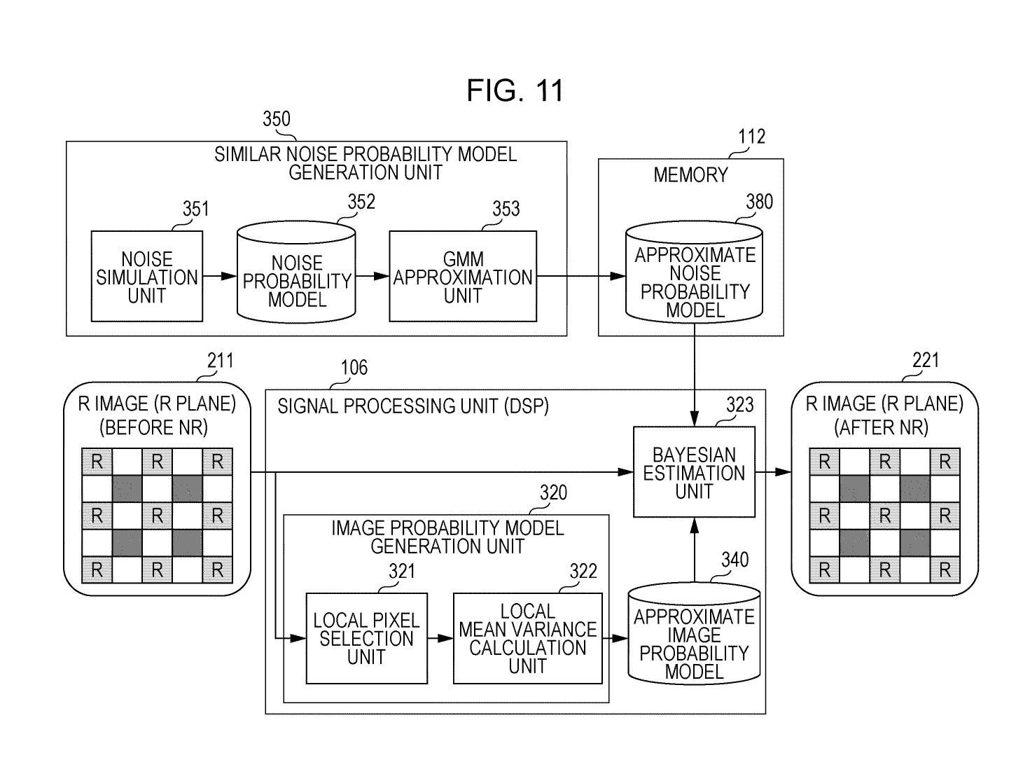

A configuration view of the image processing device also including the generation process of the approximate noise probability model 380 is illustrated in FIG. 11.

The configuration of an image processing device including an approximate noise probability model generation unit 350 generating the approximate noise probability model 380 in addition to the memory 112 storing the signal processing unit (DSP) 106 and the approximate noise probability model 380 illustrated in FIG. 10 is illustrated in FIG. 11.

The approximate noise probability model generation unit 350 includes a noise simulation unit 351 generating the noise probability model 352 and a Gaussian mixture model (GMM) approximation unit 353 generating the approximate noise probability model 380 from the noise probability model 352.

Here, while the approximate noise probability model generation unit 350 may have a configuration of being included within the imaging apparatus, the approximate noise probability model generation unit 350 may also have a configuration of being included in an independent external device such as, for example, a PC.

Details of the processes that each processing unit executes will be described below according to the configuration of the image processing device including the approximate noise probability model generation unit 350 illustrated in FIG. 11.

### 4. Process of Approximate Noise Probability Model Generation Unit

First, the process that the approximate noise probability model generation unit 350 generating the approximate noise probability model 380 executes will be described.

A noise simulation unit 351 outputs the noise probability model 352 of the imaging element by virtually generating an image in which various types of noise occurring on the imaging element overlap at an ideal pixel value not including noise and further calculating the noise probability model of the imaging element using the noise overlapped image.

Noises according to the various noise causes estimated to occur in the imaging element, specifically, the CCD image sensor 103 as the imaging element of the imaging apparatus illustrated in FIG. 1, for example, are simulated by the noise simulation unit 351. Noise modeled by a formula, noise modeled based on noise data obtained from actual measurements, or the like is able to be used in the simulation.

A process of overlapping noises according to a variety of noise occurrence causes is performed a sufficient number of times by the noise simulation unit 351 on pixel values not including all of the noise that the imaging element may take.

In so doing, a pixel value including a plurality of noises is obtained for a pixel value not including a given noise.

Since the pixel values not including noise, the pixel values including noise, and the combination therebetween are clear, pixel values not including a plurality of noises with respect to pixel values including a given noise are conversely able to be obtained.

A noise probability model is generated by using the occurrence frequency of pixel values not including a plurality of noises as a histogram.

A normalized histogram in which the sum total of the occurrence frequencies is 1 forms a portion of the noise probability model of the imaging element illustrated in FIG. 3 described earlier.

A portion of the noise probability model of the imaging element corresponds to finding the likelihood P(X|A) of Formula 1 described earlier, that is, the likelihood P(X|A) as the conditional probability of the noise pixel value X occurring in a case where the noiseless pixel value A occurs.

If a similar process is performed on a pixel value including various noises, the noise probability model of the imaging element illustrated in FIG. 4 is obtained.

The noise probability model 352 corresponds to the three-dimensional data described earlier with reference to FIG. 4.

That is, the noise probability model 352 is a model with correspondence relationship information between the pixel value of a noiseless pixel, the pixel value of a noised pixel, and the presence probability of each pixel value.

In such a manner, the noise probability model 352 with the correspondence relationship data illustrated in FIG. 4, for example, is able to be generated by analyzing an image in which various noises occurring in the imaging element are virtually overlapped through a simulation.

The noise probability model 352 corresponds to finding the likelihood P(X|A) as the conditional probability of the noised pixel value X occurring in a case where the noiseless pixel value A occurs.

That is, the noise probability model 352 corresponds to finding the likelihood P(X|A) and the likelihood P(X|B) included in Formulae 1 and 2 described earlier.

Next, the Gaussian mixture model (GMM) approximation unit 353 compresses the data size using Gaussian mixture model (GMM) approximation and outputs the approximate noise probability model 380 to the noise probability model 352.

The noise probability model 352 originates from a plurality of likelihoods P(X|A) with different values of the pixel value X of noised pixels, and the Gaussian mixture model approximation unit 353 individually approximates the respective likelihoods P(X|A).

Here, the approximation process corresponds to a process of converting the likelihood P(X|A) by applying Gaussian mixture model (GMM) approximation according to Formula 3 described earlier.

However, it is difficult to analytically find the best solution for the parameters wi, μi, and σi, that is,

wi: the weighting of the i-th normal function, and

μi, σi: the mean and the standard deviation of the i-th normal distribution,

applied to the Gaussian mixture model approximation according to Formula 3.

Therefore, the Gaussian mixture model (GMM) approximation unit 353 uses an EM (Expectation-Maximization) algorithm which is a technique of finding the next best solution through a repeating process.

The EM algorithm is a process of gradually finding the parameters of the Gaussian mixture model (GMM) by repeatedly performing a process referred to as an E-step and an M-step.

In the noise simulation unit 351, M pixel values not including a plurality of noises with respect to pixel values including one given noise are assumed to be generated, and the M pixel values are represented as xk.

Here, k is an index, and takes a value from 1 to M.

The E-step of the present embodiment is shown in the following Formula 6.

$${α}_{ik} = \frac{{w}_{i} N ( x \vert {x}_{k} , {μ}_{i} , {σ}_{i} )}{{\sum }_{j} {w}_{j} N ( x \vert {x}_{k} , {μ}_{j} , {σ}_{j} )} \qquad Formula 6$$

In Formula 6 described above, i and j represent indexes of the normal distribution used in the approximation.

Furthermore, the M-Step of the present embodiment is shown as the following Formula 7.

$${w}_{i} = \frac{{\sum }_{k = 1}^{M} {α}_{ik}}{M} \\ {μ}_{i} = \frac{{\sum }_{k = 1}^{M} {α}_{ik} {x}_{k}}{{\sum }_{k = 1}^{M} {α}_{ik}} \\ {σ}_{i}^{2} = \frac{{\sum }_{k = 1}^{M} {{α}_{ik} ( {x}_{k} - {μ}_{i} )}^{2}}{{\sum }_{k = 1}^{M} {α}_{ik}} \qquad Formula 7$$

Here, the initial values of the parameters wi, μi, and σi may be found using an appropriate clustering technique such as k-means.

Here, details of the technique of the EM algorithm are described in a variety of literatures.

For example, detailed description is given in the following literatures.

“Geoffrey J. McLachlan, Thriyambakam Krishnan, “The EM Algorithm and Extensions (Wiley Series in Probability and Statistics”, Wiley Series in Probability and Statistics 2008.”

“J. A. Bilmes, “A Gentle Tutorial of the EM Algorithm and its Application to Parameter Estimation for Gaussian Mixture and Hidden Markov Models”, Technical Report TR-97-021, International Computer Science Institute and Computer Science Division, University of California at Berkeley, April 1998.”

As described above, the Gaussian mixture model (GMM) approximation unit 353 calculates the parameters applied to the Gaussian mixture model (GMM) approximation using an EM (Expectation-Maximization) algorithm on the noise probability model 352.

The calculated parameters are data with data size of the noise probability model 352 compressed, and are output as the approximate noise probability model 380.

The process that the Gaussian mixture model (GMM) approximation unit 353 executes, that is, the generation process of the approximate noise probability model 380 corresponds to the process of converting the likelihood P(X|A) by applying Gaussian mixture model (GMM) approximation according to Formula 3 described earlier.

Here, the calculation process of the approximate noise probability model 380 corresponds to calculating the data shown in the following Formula 8 corresponding to the likelihoods P(X|A) and P(X|B) shown in Formulae 1 and 2 in Formulae 4 and 5 described earlier.

$$P ( X \vert A ) ≅ {\sum }_{i} {w ( X ( s ) )}_{i} N ( A \vert {μ ( X ( s ) )}_{i} , {σ ( X ( s ) )}_{i} ) \\ P ( X \vert B ) ≅ {\sum }_{i} {w ( X ( s ) )}_{i} N ( B \vert {μ ( X ( s ) )}_{i} , {σ ( X ( s ) )}_{i} ) \qquad Formula 8$$

In so doing, the generated approximate noise probability model 380 is stored in the memory 112 of the image processing device.

As described above, the approximate noise probability model generation unit 350 may have a configuration of being included within the image processing device illustrated in FIG. 1, for example, or may be configured by another external information processing device such as, for example, a PC.

However, in a case where the approximate noise probability model generation unit 350 is configured by an external information processing device, the approximate noise probability model 380 obtained as a result is input and stored in the memory 112 of the image processing device such as the imaging apparatus illustrated in FIG. 1.

The signal processing unit (DSP) 106 of the image processing device illustrated in FIGS. 1 and 11 execute a noise reduction process through a Bayesian estimation process using the probability models of:

(1) the approximate noise probability model 380 stored in the memory 112; and

(2) the approximate image probability model 340 generated by a process of the local pixel selection unit 321 on the input image (for example, the R image 211 illustrated in FIG. 11) and the process of the local mean variance calculation unit 322.

### 5. Generation Process of Approximate Image Probability Model

Next, the generation process of the approximate image probability model 340 executed by the signal processing unit (DSP) 106 of the image processing device illustrated in FIG. 11 will be described.

Here, as described earlier, the input image data with the respect to the signal processing unit (DSP) 106 is an image in which the reset noise is removed from the output from the CCD image sensor 103 as the imaging device of the imaging apparatus illustrated in FIG. 1 through the correlated double sampling circuit (CDS) 104 and further converted into digital data by the A/D converter 105.

The image is a mosaic image described earlier with reference to FIG. 2 in which only the pixel values corresponding to any of the colors of RGB are set for each pixel.

The mosaic image is temporarily stored in the image memory within the signal processing unit (DSP) 106.

The signal processing unit (DSP) 106 performs processing by extracting images in units of each color from the mosaic image 201. In the present example, as illustrated in FIG. 10, a noise reduction process is individually performed for each of the four color images before noise reduction (pre-NR) of the R image 211, the Gr image 212, the Gb image 213, and the B image 214.

Processing on the R image 211 is illustrated in FIG. 11 as a typical example.

The local pixel selection unit 321 of the image probability model generation unit 320 compares the pixel value of a target pixel position as the target pixel of the noise reduction process with the pixel values of the surrounding pixel positions, and selects the surrounding pixels with a difference to the pixel value of the target pixel equal to or less than a threshold value set in advance from the surrounding pixels.

Here, the threshold value may be changed dynamically according to the subject.

The target pixel position is also included in the surrounding pixel positions. Here, the local region in which the pixel value selection process is performed is a local region set in advance including the target pixel that is the noise reduction process target pixel such as, for example, the n×n pixels (n is 5, 7, 9, 11 . . . ) described with reference to FIG. 7.

The pixel values selected by the local pixel selection unit 321 are sent to the local mean variance calculation unit 322.

The local mean variance calculation unit 322 calculates the mean value and the variance value of the pixel values as statistics of the local region.

Such statistics are approximated from the probability model of the image in the local region using a normal distribution.

The result is output as the approximate image probability model 340.

The calculation of the statistics of a local region including a target pixel executed by the local mean variance calculation unit 322, that is, the calculation process of the mean value and the variance value of the pixel values will be described.

The dominant noise influenced by the number of photons out of the noises in the imaging element is optical shot noise.

Optical shot noise is recognized as having linearly proportional variance values of noise with respect to the pixel values. Therefore, the variance of noise in which various noises of the imaging element are added is approximated by the following Formula 9. The formula shown below is a formula calculating a noise variance σₙ²(s) at a pixel position s.

σₙ²(s)=d×Z(s)+e Formula 9

In Formula 9 described above, Z(s) indicates a pixel value not included in the noise at the pixel position s.

d is a coefficient derived from noise influenced by the pixel value, and e is a coefficient derived from noise not influenced by the pixel value.

Formula 9 described above corresponds to a noise probability model approximated by a single Gaussian function with a mean of 0.

Furthermore, since an ideal pixel value not including noise is unknown, the pixel value of the target pixel position including noise as a pixel value Z or the low frequency components (a pixel value on which a simple noise removal has been performed by a low frequency filter) of the pixel value of the target pixel value of Formula 9 described above is used.

In such a manner, while Formula 9 is not an accurate model of the noise at the target pixel position, Formula 9 has sufficient accuracy for use in the selection process of pixels.

A formula selecting a pixel value using Formula 9 described above and approximating a probability model of the image using a single normal distribution is shown in the following Formula 10.

$$μ ( s ) = 0 \\ ɛ = 0 \\ i = 0 \\ for ( t ∈ Local ) \{ \\ if ( \vert Z ( s + t ) - Z ( s ) \vert < h \times {σ}_{n} ( s ) ) \{ \\ \hat{Z} = Z ( s + t ) - {Z}_{Offset} \\ μ ( s ) = μ ( s ) + \hat{Z} \\ ɛ = ɛ + {\hat{Z}}^{2} \\ i = i + 1 \\ \} \\ \} \\ μ ( s ) = μ ( s ) / i \\ ɛ = ɛ / i \\ {σ ( s )}^{2} = ɛ - {μ ( s )}^{2} \qquad Formula 10$$

In Formula 10 described above, μ represents the mean value of the normal distribution, s represents the pixel position of the target pixel, σ represents the standard deviation of the normal distribution, t represents the vicinity pixel positions in a local region coordinate system with the pixel position s as the origin, Z(s) is the pixel value of the pixel position s, Z(s+t) is the pixel value of the pixel position s+t, and Zoffset is an expected value of noise not influenced by the pixel value.

h is a coefficient adjusting the selection range of the pixel values.

ε is a variable applied in the execution of an algorithm, and is a variable for calculating the squared mean value of Z.

Local indicates the local region including the noise reduction target pixel.

Formula 10 described above indicates the following process.

First, as an initialization process, initial setting of the mean value of the target pixel position s: μ(s)=0, the variable: ε=0, and the index: i=0 is performed.

The algorithm of for onward is then executed using the pixel value Z(s+t) within the local region (Local).

Here, the pixels of the local region used in the algorithm are pixels selected by the local pixel selection unit 321, that is, pixels in the vicinity of the target pixel as the noise reduction target pixel, and are selected pixels with pixel values of equal to or less than a threshold value regulated in advance of a difference with the pixel value of the target pixel.

Here, the pixel selection process is executed in the process of the if line of Formula 10 described above. The pixel selection process is a pixel selection process using the noise variance approximated according to Formula 9 described earlier.

In such a manner, the algorithm shown in Formula 10 corresponds to an algorithm described by combining the processing contents executed by the local pixel selection unit 321 and the local mean variance calculation unit 322.

Finally, the mean value μ(s) and the variance σ(s)² are calculated based on the selected pixels of the local region corresponding to the target pixel position s by executing the algorithm from for shown in Formula 10 onward.

The mean value and the variance corresponding to the target pixel as the noise reduction target are calculated according to Formula 10, and the data formed of the mean value and the variance corresponding to each pixel of the image is output as the approximate image probability model 340.

The mean value and the variance as the approximate image probability model 340 are used, for example, when calculating data shown in the following Formula 11 corresponding to the prior probabilities P(A) and P(B) as the probabilities of noiseless pixel values A and B shown in Formulae 1 and 2 occurring in Formulae 4 and 5 described earlier.

N(A|μ(s),σ(s))

N(B|μ(s),σ(s)) Formula 11

Next, the process of the Bayesian estimation unit 323 will be described.

The Bayesian estimation unit 323 executes a noise removal process on an input image (for example, the R image 211 illustrated in the drawings) using the approximate image probability model 340 generated by the process of the local pixel selection unit 321 on the input image (for example, the R image 211 illustrated in the drawings) and the process of the local mean variance calculation unit 322 and the approximate noise probability model 380 calculated in advance and stored in the memory 112.

The noise removal process executes a process according to Formula 5 described above.

That is, a pixel value Y(s) not including noise is calculated from a pixel value X(s) including noise according to Formula 5 described above.

The calculation values of:

(1) Formula 8 described earlier corresponding to the approximate noise probability model 380; and

(2) Formula 11 described earlier corresponding to the approximate image probability model 340 are used in the calculation process.

The pixel value Y(s) of a noiseless pixel at the target pixel position s is calculated by inputting such data and the pixel value X(s) of a noised pixel at each target pixel position s according to Formula 5.

The pixel value calculation process is performed on the pixel value of a pixel (target pixel) including all of the input noise, and finally, the noise removed image, for example, the R image (post-NR) 221 illustrated in FIGS. 10 and 11 is generated and output.

Similar processes are also executed for other color images, and the noise reduced images 221 to 224 of each color image (R, Gr, Gb, and B planes) are generated and output.

In such a manner, an image from which noise is removed is able to be generated through the process of an embodiment of the present disclosure from a mosaic image imaged by a single panel type color imaging element using the color filter arrangement of FIG. 2, for example.

### 6. Embodiment Variation

While the embodiment described above is a noise removal process using an approximate noise probability model and an approximate image probability model, in a case where there are sufficient calculation resources, the approximation process may be omitted.

That is, a configuration of using the noise probability model 352 illustrated in FIG. 11 instead of the approximate noise probability model 380 illustrated in FIGS. 10 and 11 may be adopted.

Further, a configuration using a histogram of the pixel values of a local region created without performing a pixel selection process instead of the approximate image probability model 340 illustrated in FIGS. 10 and 11 may be adopted.

Further, a configuration of performing a process using Formula 1 instead of Formula 5 representing an approximated noise removal process may be adopted.

### 7. Summary of Configuration of Embodiments of Present Disclosure

The configurations according to embodiments of the present disclosure have been described in detail above while referring to specific embodiments. However, it is self-evident that those skilled in the art may correct and substitute the embodiments without departing from the gist of the embodiments of the present disclosure. That is, the embodiments of the present disclosure have been disclosed in the form of examples, and are not to be interpreted as limiting. The scope of the claims is to be consulted to determine the gist of the embodiments of the present disclosure.

Here, the technology disclosed in the present specification is able to adopt the following configurations.

(1) An image processing device including: an image probability model generation unit calculating a feature amount in units of local regions as division regions of a captured image of an imaging apparatus and generating an image probability model configured by the calculated feature amount, the image probability model indicating the generation probability of each noiseless pixel value; a memory storing a noise probability model generated from imaging element-dependent noise characteristic information, the noise probability model indicating a conditional probability of a given noised pixel value being generated in a case where a given noiseless pixel value is generated; and a Bayesian estimation unit generating a noise reduced image in which the noise of the captured image is reduced through a Bayesian estimation process in which the image probability model and the noise probability model are applied.

(2) The image processing device according to (1) described above, wherein the image probability model generation unit includes: a local pixel selection unit selecting, from a local region including a noise reduction process target pixel, a pixel in which a pixel value difference with the noise reduction process target pixel is equal to or less than a threshold value as a reference pixel; and a local mean variance calculation unit calculating a mean value and a variance value of the reference pixel selected by the local pixel selection unit, wherein the image probability model is an approximate image probability model formed of a calculation value of the local mean variance calculation unit.

(3) The image processing device according to any one of (1) and (2) described above, wherein the noise probability model stored in the memory is an approximate noise probability model generated by applying a Gaussian mixture model approximation representing an arbitrary distribution by adding a plurality of Gaussian distributions.

(4) The image processing device according to any one of (1) to (3) described above, wherein the noise probability model stored in the memory is an approximate noise probability model generated by applying a Gaussian mixture model approximation representing an arbitrary distribution by adding a plurality of Gaussian distributions, and parameters of the Gaussian mixture model approximation are parameters calculated by applying an EM (Expectation-Maximization) algorithm.

(5) The image processing device according to any one of (1) to (4) described above, wherein the noise probability model stored in the memory is a noise probability model generated by applying simulation process data virtually generating a pixel value in which noise signals according to a plurality of noise generation causes occurring on a captured image of an imaging element overlap.

(6) The image processing device according to any one of (1) to (5), wherein the image probability model generation unit generates an approximate image probability model formed of a single normal distribution, the noise probability model stored in the memory is an approximate noise probability model generated by applying a Gaussian mixture model approximation representing an arbitrary distribution by adding a plurality of Gaussian distributions, and the Bayesian estimation unit generates a noise reduced image in which the noise of the captured image is reduced through a Bayesian estimation process applying the approximate image probability model and the approximate noise probability model.

(7) The image processing device according to any one of (1) to (6) described above, wherein the image processing device further includes: a noise probability model generation unit generating the noise probability model, wherein the noise probability model generation unit includes a noise simulation processing unit virtually generating a pixel value in which noise signals according to a plurality of noise generation causes occurring on a captured image of an imaging element overlap, and a Gaussian model approximation unit generating an approximate noise probability model through a Gaussian mixture model (GMM) approximation process on data generated by the noise simulation processing unit.

(8) An imaging apparatus including: an imaging unit including an imaging element; an image probability model generation unit calculating a feature amount in units of local regions as division regions of a captured image input from the imaging unit and generating an image probability model configured by the calculated feature amount, the image probability model indicating the generation probability of each noiseless pixel value; a memory storing a noise probability model generated from imaging element-dependent noise characteristic information, the noise probability model indicating a conditional probability of a given noised pixel value being generated in a case where a given noiseless pixel value is generated; and a Bayesian estimation unit generating a noise reduced image in which the noise of the captured image is reduced through a Bayesian estimation process in which the image probability model and the noise probability model are applied.

Furthermore, the method of the processes executed on the device and the like described above and the program executing the processes are also included in the configuration of the embodiments of the present disclosure.

Further, the series of processes described in the specification is able to be executed by hardware, software, or a composite configuration of both. In a case where the processes are executed by software, the processes are able to be executed by a program on which the processing sequence is recorded being installed and executed on a memory within a computer in which dedicated hardware is built in or the program being installed and executed on a general-purpose computer able to execute various processes. For example, the program is able to be recorded on a recording medium in advance. Other than installing on a computer from a recording medium, a program is able to be received via a network such as a LAN (Local Area Network) or the Internet and installed on a recording medium such as a built-in hard disk.

Here, rather than being executed in time series according to the description, the various processes described in the specification may also be executed parallel or individually according to the processing capability of the device executing a process or according to the use. Further, a system in the present specification is a logical group configuration of a plurality of devices, and is not limited to devices of each configuration being within the same housing.

The present disclosure contains subject matter related to that disclosed in Japanese Priority Patent Application JP 2011-261035 filed in the Japan Patent Office on Nov. 29, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing device comprising:
an image probability model generation unit calculating a feature amount in units of local regions as division regions of a captured image of an imaging apparatus and generating an image probability model configured by the calculated feature amount, the image probability model indicating a generation probability of each noiseless pixel value;
a memory storing a noise probability model generated from imaging element-dependent noise characteristic information, the noise probability model indicating a conditional probability of a given noised pixel value being generated in a case where a given noiseless pixel value is generated; and
a Bayesian estimation unit generating a noise reduced image in which the noise of the captured image is reduced through a Bayesian estimation process in which the image probability model and the noise probability model are applied.

2. The image processing device according to claim 1,
wherein the image probability model generation unit includes:
a local pixel selection unit selecting, from a local region including a noise reduction process target pixel, a pixel in which a pixel value difference with the noise reduction process target pixel is equal to or less than a threshold value as a reference pixel; and
a local mean variance calculation unit calculating a mean value and a variance value of the reference pixel selected by the local pixel selection unit,
wherein the image probability model is an approximate image probability model formed of a calculation value of the local mean variance calculation unit.

3. The image processing device according to claim 1,
wherein the noise probability model stored in the memory is an approximate noise probability model generated by applying a Gaussian mixture model approximation representing an arbitrary distribution by adding a plurality of Gaussian distributions.

4. The image processing device according to claim 1,
wherein the noise probability model stored in the memory is an approximate noise probability model generated by applying a Gaussian mixture model approximation representing an arbitrary distribution by adding a plurality of Gaussian distributions, and
parameters of the Gaussian mixture model approximation are parameters calculated by applying an EM (Expectation-Maximization) algorithm.

5. The image processing device according to claim 1,
wherein the noise probability model stored in the memory is a noise probability model generated by applying simulation process data virtually generating a pixel value in which noise signals according to a plurality of noise generation causes occurring on a captured image of an imaging element overlap.

6. The image processing device according to claim 1,
wherein the image probability model generation unit generates an approximate image probability model formed of a single normal distribution,
the noise probability model stored in the memory is an approximate noise probability model generated by applying a Gaussian mixture model approximation representing an arbitrary distribution by adding a plurality of Gaussian distributions, and
the Bayesian estimation unit generates a noise reduced image in which the noise of the captured image is reduced through a Bayesian estimation process applying the approximate image probability model and the approximate noise probability model.

7. The image processing device according to claim 1,
wherein the image processing device further includes:
a noise probability model generation unit generating the noise probability model,
wherein the noise probability model generation unit includes
a noise simulation processing unit virtually generating a pixel value in which noise signals according to a plurality of noise generation causes occurring on a captured image of an imaging element overlap, and
a Gaussian model approximation unit generating an approximate noise probability model through a Gaussian mixture model (GMM) approximation process on data generated by the noise simulation processing unit.

8. An imaging apparatus comprising:
an imaging unit including an imaging element;
an image probability model generation unit calculating a feature amount in units of local regions as division regions of a captured image input from the imaging unit and generating an image probability model configured by the calculated feature amount, the image probability model indicating a generation probability of each noiseless pixel value;
a memory storing a noise probability model generated from imaging element-dependent noise characteristic information, the noise probability model indicating a conditional probability of a given noised pixel value being generated in a case where a given noiseless pixel value is generated; and
a Bayesian estimation unit generating a noise reduced image in which the noise of the captured image is reduced through a Bayesian estimation process in which the image probability model and the noise probability model are applied.

9. An image processing method executing on an image processing device, comprising:
an image probability model generating process including calculating a feature amount in units of local regions as division regions of a captured image of an imaging apparatus and generating an image probability model configured by the calculated feature amount, the image probability model indicating a generation probability of each noiseless pixel value; and
a Bayesian estimation process generating a noise reduced image in which the noise of the captured image is reduced through Bayesian estimation by applying a noise probability model generated from imaging element-dependent noise characteristic information, the noise probability model indicating a conditional probability of a given noised pixel value being generated in a case where a given noiseless pixel value is generated, and the image probability model.

10. A program causing an image process to be executed on an image processing device, comprising:
an image probability model generating process including calculating a feature amount in units of local regions as division regions of a captured image of an imaging apparatus and generating an image probability model configured by the calculated feature amount, the image probability model indicating a generation probability of each noiseless pixel value; and
a Bayesian estimation process generating a noise reduced image in which the noise of the captured image is reduced through Bayesian estimation by applying a noise probability model generated from imaging element-dependent noise characteristic information, the noise probability model indicating a conditional probability of a given noised pixel value being generated in a case where a given noiseless pixel value is generated, and the image probability model.
